(19) United States
(12) Patent Application Publication
(10) Pub. No.: US 2011/0276373 A1
(43) Pub. Date: Nov. 10, 2011

(54) Online coupon distribution system and method

(76) Inventors: Nicholas Juszczak, Levittown, NY (US); Marjorie Juszczak, Levittown, NY (US); Judith Campion, White Plains, NY (US)

(21) Appl. No.: 12/662,851

(22) Filed: May 6, 2010

(51) Int. Cl. G06Q 30/00; G06F 15/16; G06Q 20/00; G06Q 10/00; G06Q 50/00

(52) U.S. Cl. 705/14.13; 705/14.15; 709/206

(57) ABSTRACT

The online coupon distribution system and method distributes discount coupons through a website. The website is designed and constructed to include a “trifold” process that blends discount coupon purchasing with cost effective advertising and charitable contributions into a powerful web presence. The process is called cooperative couponing. The system sells coupons and allocates generated revenue among merchants, a website principal, and a designated charity. The website identifies local merchants in a geographic area. Coupons are electronically distributed on a daily basis. The website features target goal coupons, two subsidiary coupons providing discounts, and five additional weekly merchant coupons strategically placed on the website. The website permits website users to designate a charitable contribution to a charity of their choice based on their coupon purchase.

### BACKGROUND OF THE INVENTION

1. Field of the Invention

The present invention relates to coupon distribution systems, and more particularly to an online coupon distribution system and method for performing online coupon distribution and distributing a portion of the coupon purchase price to designated charity organizations.

2. Description of the Related Art

In general commerce, marketers and sellers of goods and services often issue and distribute paid and/or free coupons as payment means, discount means, or exchange means for goods or services. Coupons are distributed with certain conditions, such as a discount rate, a validity term, and the like. Customers can purchase goods at a discounted price or obtain gifts by using the coupons.

In a typical coupon distribution method, a seller issues coupons and provides them to customers directly or upon delivery of goods. The coupons are returned to the sellers when the customers use the coupons at goods stores.

Recently, with the development of the Internet, goods stores or service providers build their website in a virtual space and provide coupons on the website to customers. This eliminates the need for customers to directly visit retail stores or service providers. The online coupons may be printed by an output device, such as a printer, or downloaded as an image with a unique number to a mobile terminal, such as a mobile phone, are presented to stores.

However, with the increasing number of such coupon-providing websites, there is corresponding increasing competition for visitors who ultimately become customers by making a coupon purchase. A new website entering the fray must distinguish itself from all the other coupon websites in existence. There is a need for a mechanism to drive traffic to the website and increase customer satisfaction as well as merchant fulfillment.

Thus, an online coupon distribution system and method solving the aforementioned problems is desired.

### SUMMARY OF THE INVENTION

The online coupon distribution system and method distributes discount coupons through a website. The website is designed and constructed to include a “trifold” process that blends discount coupon purchasing with innovative, cost effective advertising and with charitable contributions into a powerful web presence. The process described herein is called cooperative couponing. The system sells coupons and allocates generated revenue among merchants, the website principal, and a designated charity. The website identifies local merchants in a geographic area. Coupons are electronically distributed on a daily basis. The website features target goal coupons, two subsidiary coupons providing discounts, and five additional weekly merchant coupons strategically placed on the website. The website provides website users with an incentive to become paying customers by allowing the users to designate a charitable contribution based upon their coupon purchase. The website provides an e-commerce solution that includes a “Buy” or “Purchase” button, enabling subscribers to purchase the coupons online. Consequently, the subscriber will be able to print and redeem the coupons at a participating local merchant's place of business. Some offers will be available for one day only, while others will be available for a week.

The unique trifold process begins principally with the sale of online discount coupons. Merchants, consumers, and charitable causes (local, regional, national, international) are joined in a cooperative arrangement through the Internet, benefiting all three. The merchant attracts new clients without the risk associated with traditional advertising, the shopper enjoys a discounted shopping experience and gets to try new products and services, and the local community is supported by the merchant and consumer contributing to a cause.

These and other features of the present invention will become readily apparent upon further review of the following specification and drawings.

### BRIEF DESCRIPTION OF THE DRAWINGS

FIG. 1 is a block diagram of a network system for providing an online coupon distribution system and method according to the present invention.

FIG. 2 is a block diagram of an alternative network system for providing an online coupon distribution system according to the present invention.

FIG. 3 is a flowchart showing operation of an online coupon distribution system and method according to the present invention.

FIG. 4 is a block diagram showing e-commerce money flow through an online coupon distribution system according to the present invention.

FIG. 5 is a screenshot showing an exemplary website home page in an online coupon distribution system according to the present invention.

FIG. 6 is a block diagram showing the flow of coupons and money through an online coupon distribution system according to the present invention.

Similar reference characters denote corresponding features consistently throughout the attached drawings.

### DETAILED DESCRIPTION OF THE PREFERRED EMBODIMENTS

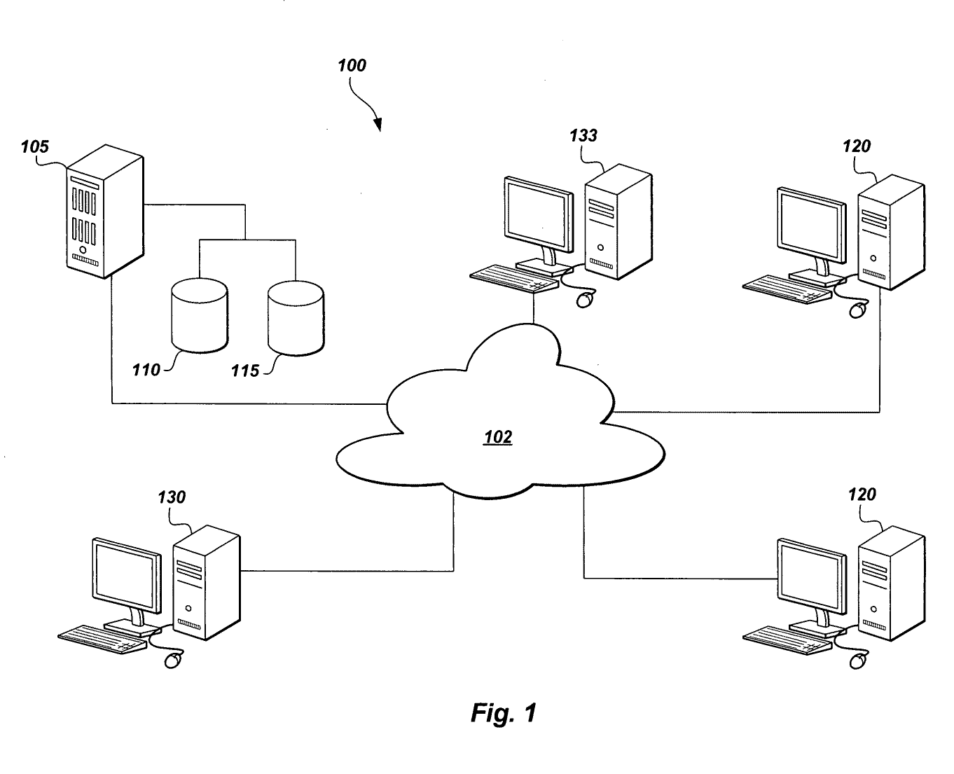

As shown in FIGS. 1-3 and 5, the online coupon distribution system comprises an online coupon distribution website 500, which provides a consumer with coupons to purchase retail products and services. The infrastructure 100 utilized by the website 500 includes the Internet 102 and a plurality of servers and web-enabled user devices. The website 500 may be hosted on a server 105 accessible via the Internet 102. User devices include the customers' web-enabled computers 120, at least one web-enabled merchant user computing device 130, and at least one web enabled charitable entity computing device 133.

The website may have mass data storage in the form of one or more mass storage units, such as hard drive 110 and hard drive 115, which store data and applications related to operations of the website 500. The customers' web-enabled computers 120 access pages on the website 500 in order to purchase retail coupons and contribute to charities.

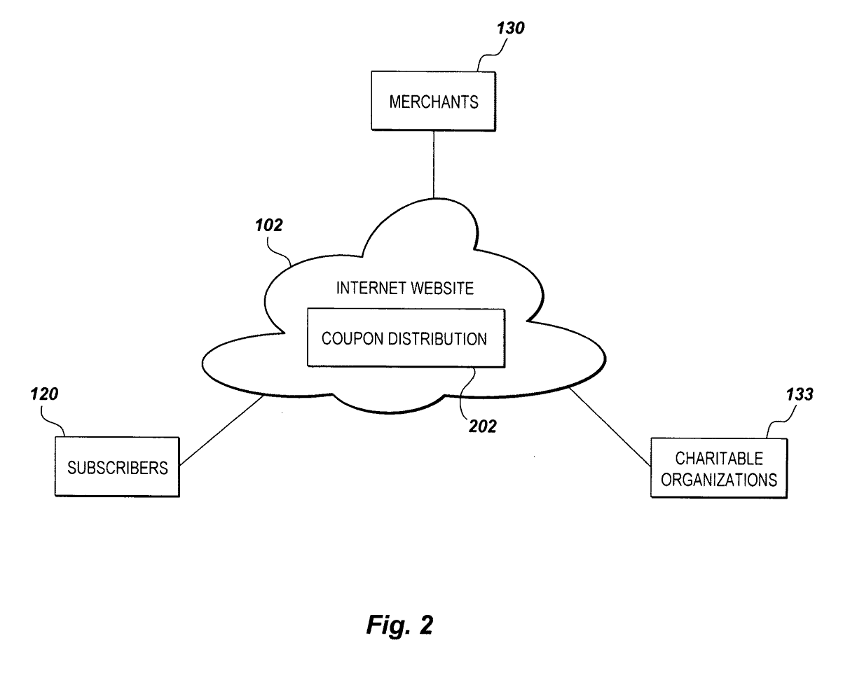

As shown in FIG. 2, the online coupon distribution system can have a website that does not utilize the specific server 105 shown in FIG. 1, but rather utilizes scalable “cloud computing” resources 202 accessible via the Internet 102 (as used herein, the term “cloud computing” means a system where the website does not own or operate the technological infrastructure, but rents the software applications and hardware from third party providers via the Internet). The scalable cloud computing resources 202 obviate the necessity of a website operator purchasing expensive server equipment, mass storage devices, and the like.

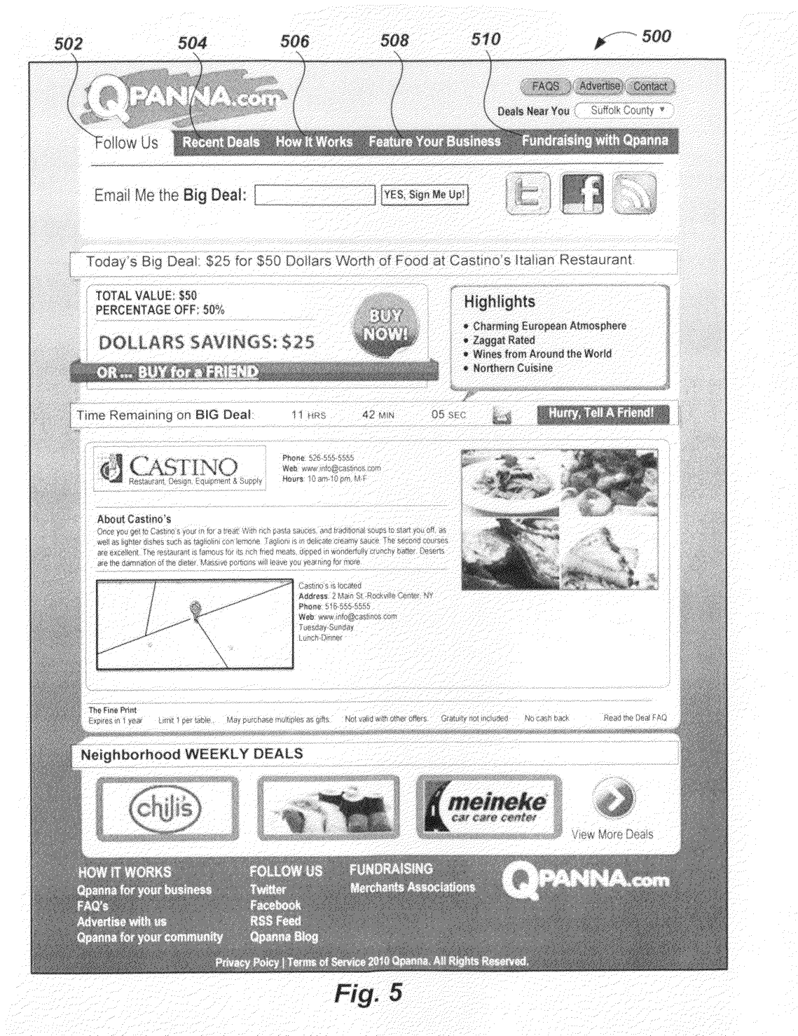

The website 500 is designed and constructed to include a “trifold” process that blends discount coupon purchasing with innovative cost effective advertising and charitable contributions into a powerful web presence. The process described herein is called cooperative couponing. As shown in FIG. 5, the website 500 has at least one page that presents option 502, which, when clicked on, provides more information about the website 500 to the user. Additional tabs that provide operational information to the user include tab 504 “Recent Deals”, tab 506 “How it Works” tab 508 “Feature Your Business” and tab “510 “Fundraising with Qpanna (the website 500)”.

With the primary objective being to sell discounted coupons through the website, local merchants in an identified geographic area will be included is and coupons will be electronically distributed on a daily basis featuring: target goal coupons; two subsidiary coupons providing discounts; and five additional weekly merchant coupons strategically placed on the website 500. Subscribers will purchase the coupons online by clicking on a “Buy” or “Purchase” button on the website 500.

Consequently, the subscriber will be able to print and redeem them at a participating local merchant's place of business. Some offers will be available for one day only, while others will be available for a week.

The unique trifold process begins principally with the sale of online discount coupons. Merchants, consumers, and charitable causes (local, regional, national, international) are joined in a cooperative arrangement through the Internet, benefiting all three. The merchant attracts new clients without the risk associated with traditional advertising, the shopper enjoys a discounted shopping experience and gets to try new products and services, and the local community is supported by the merchant/consumer contributing to a cause.

The primary objective is to sell discounted coupons online through the qpanna.com website, sold by the website 500 (Qpanna.com) for participating local merchants and businesses to assist in obtaining new customers. To meet this objective, the website 500 builds and expands email targeted subscriptions, initially within local communities, e.g., Long Island communities. Qpanna coupons will be electronically distributed on a daily basis featuring: (A) target goal couponing (subscribers meet a target objective for the discount, if the objective is not met no coupons are purchased); (B) two subsidiary daily coupons providing discounts; (C) five additional weekly merchant coupons strategically placed on the web page. Specifically subscribers will purchase the coupons (A, B, or C) online by clicking on a “BUY” button. Consequently, the subscriber will be able to print and redeem them at participating local merchants' places of business. These offers (i.e., A and B) will available for one day only. With respect to offer C, the offer is available for one week.

With respect to options A, B, or C, revenue is generated when the customer/subscriber purchases the discounted value of the coupon. For example, the user purchases a $25 coupon for $50 worth of groceries). A negotiated percentage of the generated revenue (e.g., 10-25%), is the principle revenue stream for the website 500, with the difference going back to the merchant and a percentage from both merchant and the website 500 going to customer selected charitable community organizations, e.g., schools, churches, synagogues, senior citizen centers, homeless shelters, food banks, and the like). With each coupon purchase, the buyer selects the desirable charitable institution. Qpanna, following arrangements with the merchants, directs funds to the subscriber and customer-selected institution.

Only CAN-SPAM compliant subscribers are recruited. The subscribers may be recruited through traditional advertising media, such as print, radio television, movie theatres, shopping malls, and the like, and by staff at kiosks, stations, booths at local events (e.g., fairs, festivals, seasonal events) using Internet connected laptops as well as traditional collateral sign-ups (free forms sign-ups), online Internet search engines and social networks (Google, Yahoo, Sing, Facebook, Twitter, and the like) direct staff contact with community groups leaders and administrators (e.g., PTA. Boys Clubs, Girls Clubs, Boy Scouts of America, Girl Scouts of America, YMCA, YMHA, Libraries, Senior and Community Colleges), Home Shows (Boat Shows, Baby Shows, Home Improvement shows1 etc).

The website 500 has informative pages that tout to subscribers the benefits of cooperative couponing. Such benefits include, but are not limited to, outstanding coupon discounts coupled with charitable contributions, subscription and cooperative participation being free, and direct e-payments to local charitable institutions.

Local merchants are recruited via sales force through direct visit, phone contact, or Internet/e-mail. The website 500 provides a subscription sign-up form including opt out procedures disenrollment and a field in which the merchant must certify Controlling the Assault of Non-Solicited Pornography And Marketing Act of 2003 (CAN-SPAM) compliance before the merchant subscription is accepted by the system.

The philosophy and benefit of user participation is due to the fact that merchants are not asked to pay for any advertising, except for the coupon discount at the time of coupon redemption by the consumer. Each merchant's offer must adhere to specific guidelines promulgated by the website 500, i.e., the offers must be genuinely consumer oriented, specifying genuine discounts (no fluff), validity dates, disclaimers, and the like. For example, a grocery store may offer a coupon conspicuously specifying $50.00 WORTH OF GROCERIES FOR $25.00; FROM STORE X VALID FOR 1 YEAR FROM PURCHASE DATE, NOT TO BE COMBINED WITH ANY OTHER OFFERS OR DISCOUNTS; $30 FOR 1 MONTH YOGA CLASSES (REGULAR PRICE $150-SAVINGS 5120.00, UNLIMITED VISITS LIMITED TO WITHIN A 4 WEEK PERIOD, NOT VALID WITH OTHER OFFERS OR PROMOTIONS, DISCOUNTS NOT TO BE COMBINED, NEW CUSTOMERS ONLY).

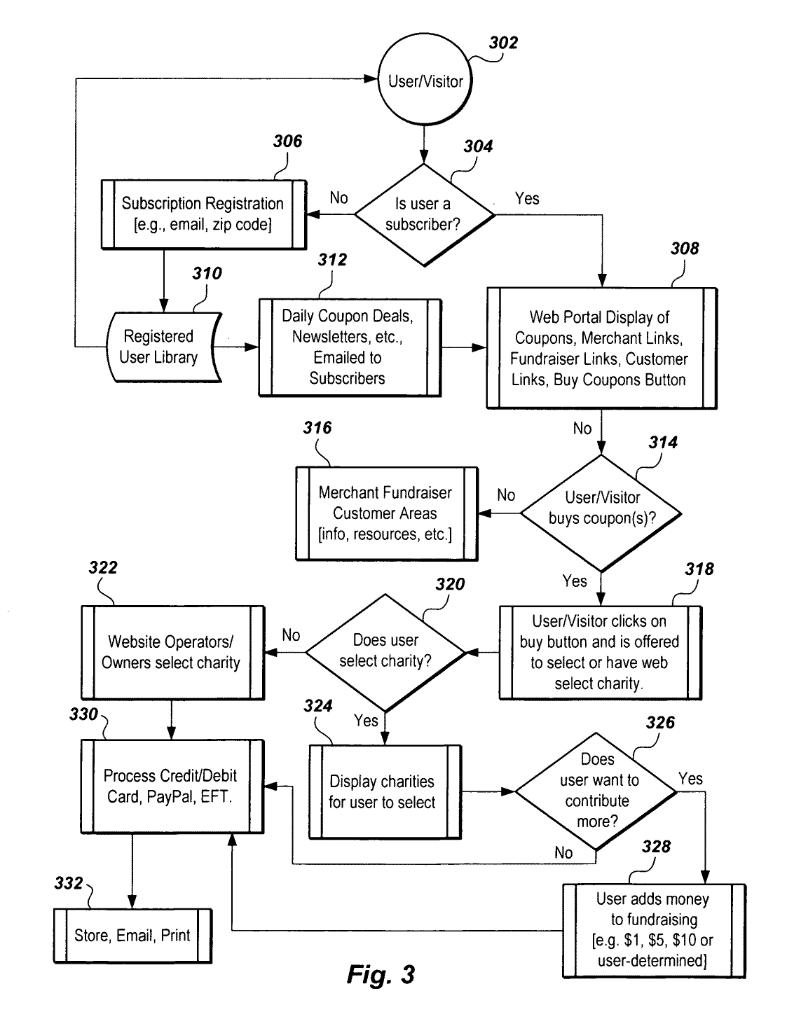

As shown in FIG. 3, a user accesses the website 500 at step 302. At step 304, if the user is a subscriber, the user is automatically directed to step 308, which presents a web portal display of coupons, merchant links, and the like. If the user is not a subscriber, the user may subscribe and register at step 306. At step 310, the user information is stored in a registered user library. At step 312, coupon deal information is emailed to the subscribers. At step 314, if the user does not buy a coupon the user is directed to step 316, where the user can view merchant fundraiser and resource information. Otherwise, the user is directed to step 318, where the user clicks on a buy button confirming coupon purchase.

The charity is either selected by the user at steps 320, 324, 326 and 328, or automatically selected by the website 500 at step 322. The payout is electronically distributed at step 330, a record of which is stored, emailed, and printed at step 332. The revenue stream is monitored via e-mail communications to participants on a daily basis. When a consumer-subscriber clicks on a “BUY” or “PURCHASE” button, the website provides the consumer access to a credit card/PayPal area in which the consumer can purchase the coupon.

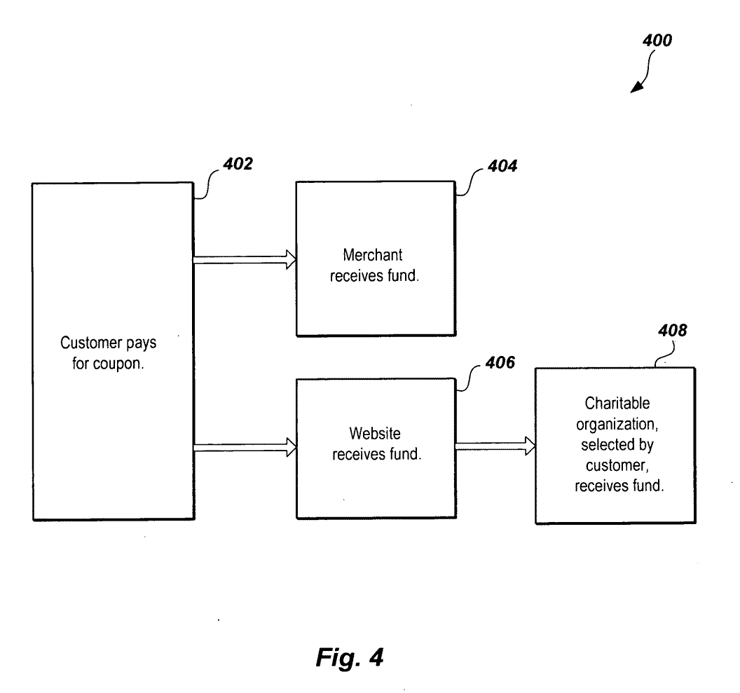

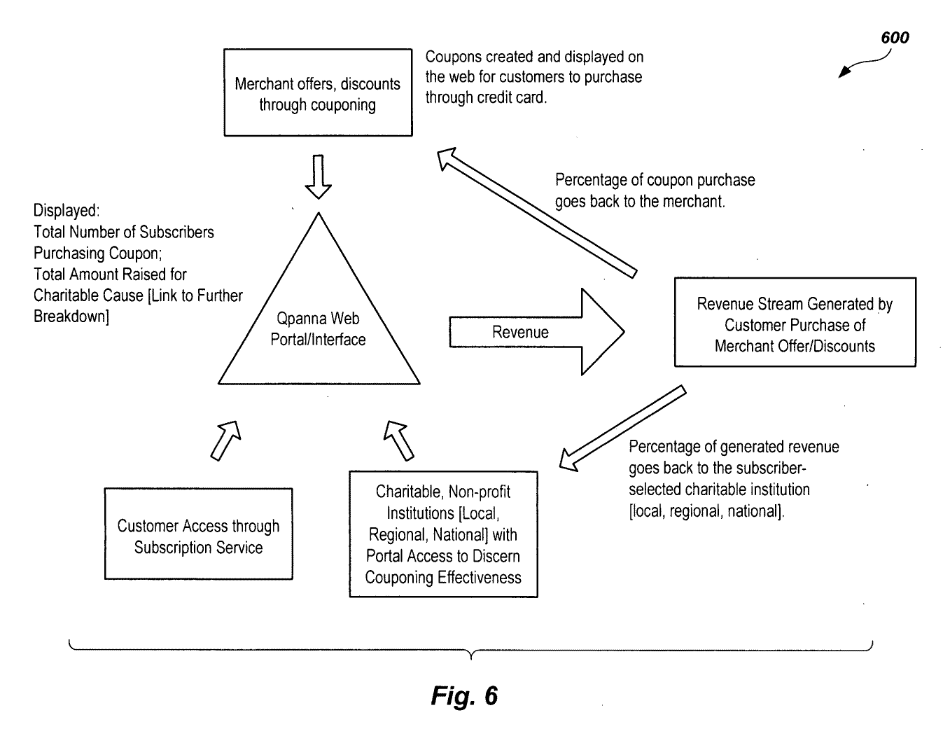

All payment is directed to Qpanna. Qpanna then pays the contractually agreed percentage of the total coupon revenue to the merchant for that merchant's coupon in the following manner; (A) daily coupon merchants are paid on a daily basis either through a mailed check or electronic funds transfer (EFT); (B) weekly coupon merchants are paid at the end of the week through mailed check or electronic funds transfer. As shown in FIG. 4, money flow overview 400 illustrates that the act of paying for the coupon 402 automatically triggers merchant receipt of funds 404, website receipt of funds 406, and charitable entity receipt of funds 408. FIG. 6 shows money flow dependencies 600. Customer access, an operational e-commerce website, merchants offering discounts through couponing, a charitable entity, and a revenue allocation formula are required for completeness of the money flow cycle in the business model of the website 500.

The Cooperative Coupon process joins local community members, e.g., Long Island, N.Y. community members, local retailers who provide goods and services, and customers who benefit from these goods and services. Thus, for all participants, the method provides interactive, cooperative coupon buying over the Internet. The method provides increased business for the participating Merchant and valuable savings for the customer/subscriber. The cooperative buying arrangement, i.e., recruitment of a minimum number of sold coupons to activate the discount, provides opportunity for both merchants and customers to help the community in that the system guarantees charitable contributions via fixed revenue sharing between merchant and customer.

Because the customers benefit by participation in cooperative purchasing of deeply discounted goods and services from merchants participating in the website 500, the consumer-subscriber base is expected to expand.

The website 500 is expected to drive customer satisfaction via the offering and distribution of high quality coupons, which, in turn, leads to increased interaction and quantity of consumer-subscribers with merchants.

The website has features that encourage subscribers to recruit other subscribers based on relationships, such as family, friends, coworkers, facebook acquaintances, and the like. with ease of website use and promotional offers through increased membership.

The website 500 facilitates cross promotion by giving merchants the opportunity to combine and supplement traditional marketing avenues. Fund raising opportunities are provided and may also increase the subscription base. The business model of website 500 predicts that increasing subscribers leads to more coupons being sold on the website, which leads to increasing revenue for the website 500, merchants, and charitable institutions.

Merchant agrees to advertise and then negotiates terms with Qpanna. Advertising fees are not paid up-front to Qpanna. Coupons are made available at a good value to attract new customers to the merchant. Merchant is paid by Qpanna for a portion of the value, and incurs remaining cost of value of coupon when coupon is redeemed.

Customers receive deal updates on the website 500 through many channels. The website 500 notifies the customers via daily emails, RSS feed updates, Facebook messages, Twitter feeds, content updates of website 500 and/or mobile web site updates.

The website money flow policy comprises the customer purchasing a coupon offered by the website 500. The money is paid to an e-banking account owned by the website principals. The website 500 offers a charity selection menu, from which the user can select which charity shall be offered a donation among a plurality of charities available from the selection menu. The website e-banking account then automatically pays a percentage of the purchase to the charitable organization. The business model contemplates that charitable organizations that benefit from donations routed from website 500 may actively campaign to attract more subscribers to the website 500.

Specifics of the website money flow are shown in FIGS. 3, 4, and 6. The website 500 offers coupons of great value to the customer for purchase. The website 500 accepts customer specification of a desired charity to support. Meanwhile, the merchant pays no up-front advertising fees. The merchant receives a portion of the coupon's purchase price, whether or not the coupon is used. Website principals receive a remainder of the coupon's purchase price. The charitable organization selected by the customer receives a portion of Qpanna sales from the consumer-purchased coupon.

With respect to reporting, the website offers metrics tools, which allow Merchants to specify reports that analyze effectiveness of the coupons and obtain more information about their new customers. Charitable organizations will have reporting capability to see the kinds of coupons that generated their donations. Initial reports will be simplistic, but can become very advanced, providing important merchandising information for both merchants and charitable organization.

It is to be understood that the present invention is not limited to the embodiment described above, but encompasses any and all embodiments within the scope of the following claims.

We claim:

1. An online coupon distribution system, comprising:
an e-commerce website;
means for storing coupons to be sold on the e-commerce website;
means for registering coupon customers of the e-commerce website;
means for allowing registered coupon customers to purchase the coupons from the e-commerce website; and
means for distributing proceeds from the purchase of coupons to a principal of the e-commerce website, merchants associated with the coupons, and a charitable entity, the proceeds distribution being allocated according to a predetermined allocation formula.

2. The online coupon distribution system according to claim 1, wherein the e-commerce website is operable within scalable cloud computing resources accessible via the Internet.

3. The online coupon distribution system according to claim 1, further comprising means for accepting customer selection of the charitable entity.

4. The online coupon distribution system according to claim 1, further comprising:
means for registering the merchants associated with the coupons; and
means for identifying a geographic area in which the merchants operate.

5. The online coupon distribution system according to claim 1, further comprising means for electronically distributing, on a daily basis, a first plurality of target goal coupons, a second plurality of subsidiary discount coupons, and a third plurality of additional weekly merchant coupons offered for sale on said e-commerce website.

6. The online coupon distribution system according to claim 1, further comprising means for making available a first predetermined number of coupon offers for one day only and a second predetermined number of coupon offers for one week.

7. The online coupon distribution system according to claim 1, wherein said e-commerce website further comprises means for building and expanding e-mail targeted subscriptions within designated geographical areas.

8. The online coupon distribution system according to claim 1, further comprising paying daily coupon merchants on a daily basis, and paying weekly coupon merchants on a weekly basis.

9. The online coupon distribution system according to claim 1, further comprising means for sending deal updates to customers via daily e-mails.

9. The online coupon distribution system according to claim 1, further comprising means for sending deal updates to customers via content updating of said e-commerce website.

10. The online coupon distribution system according to claim 1, further comprising means for sending deal updates to customers via RSS feed updates, social networking messages, microblogging services, and content pushing to mobile devices of said customers.

11. The online coupon distribution system according to claim 1, further comprising:
means for offering metrics tools allowing merchants to specify reports analyzing effectiveness of their coupons and obtaining more information about their customers; and
means for offering metrics tools allowing charitable organizations to see the kinds of coupons generating donations to the charitable organizations.

12. A computer-implemented online coupon distribution method, comprising the steps of:
storing coupons to be sold on an e-commerce website;
registering coupon customers of the e-commerce website;
allowing registered coupon customers to purchase the coupons from the e-commerce website; and
automatically distributing proceeds from the purchase of coupons to a principal of the e-commerce website, merchants associated with the coupons, and a charitable entity, the proceeds distribution being allocated according to a predetermined allocation formula.

13. The computer-implemented online coupon distribution method according to claim 12, further comprising the step of accepting customer selection of said charitable entity.

14. The computer-implemented online coupon distribution method according to claim 12, further comprising the steps of:
registering said merchants associated with said coupons; and
identifying a geographic area in which said merchants operate.

15. The computer-implemented online coupon distribution method according to claim 12, further comprising the step of electronically distributing, on a daily basis, a first plurality of target goal coupons, a second plurality of subsidiary discount coupons, and a third plurality of additional weekly merchant coupons strategically located on said e-commerce website.

16. The computer-implemented online coupon distribution method according to claim 12, wherein a first predetermined number of coupon offers is made available for one day only and a second predetermined number of coupon offers is made available for one week.

17. The computer-implemented online coupon distribution method according to claim 12, wherein said e-commerce website builds and expands e-mail targeted subscriptions within designated geographical areas.

18. The computer-implemented online coupon distribution method according to claim 12, further comprising the steps of paying daily coupon merchants on a daily basis, and paying weekly coupon merchants on a weekly basis.

19. The computer-implemented online coupon distribution method, according to claim 12, further comprising the step of sending deal updates to customers via daily emails, RSS feed updates, social networking messages, microblogging services, content updating of said e-commerce website, and content pushing to mobile devices of said customers.

20. The computer-implemented online coupon distribution method according to claim 12, further comprising the steps of:
offering metrics tools allowing merchants to specify reports analyzing effectiveness of their coupons and obtaining more information about their customers; and
offering metrics tools allowing charitable organizations to see the kinds of coupons generating donations to the charitable organization.
